(19) United States
(12) Patent Application Publication
(10) Pub. No.: US 2009/0117872 A1
(43) Pub. Date: May 7, 2009

(54) PASSIVELY POWERED ELEMENT WITH MULTIPLE ENERGY HARVESTING AND COMMUNICATION CHANNELS

(76) Inventors: Joel A. Jorgenson, Forgo, ND (US); Michael J. Schmitz, Fargo, ND (US); Brian M. Morlock, West Fargo, ND (US); Bradley R. Thurow, Fargo, ND (US)

Correspondence Address: BLAKELY, SOKOLOFF, TAYLOR & ZAFMAN LLP, 1279 Oakmead Parkway, Sunnyvale, CA, 94085-4040, US

(21) Appl. No.: 12/181,917

(22) Filed: Jul. 29, 2008

Related U.S. Application Data
(60) Provisional application No. 60/985,478, filed on Nov. 5, 2007.

(51) Int. Cl. H04B 1/16

(52) U.S. Cl. 455/334

(57) ABSTRACT

A passively powered element with multiple energy harvesting and communication channels is described. The passively powered element may include a number of antennae tuned to transmit and to receive radio frequency (RF) signals at multiple different frequencies. The passively powered element may further include a number of rectifiers, each coupled to a distinct one of the antennae, to convert energy of the RF signals into direct current (DC) power and to receive data in the RF signals. An electronic device is coupled to the rectifiers to receive the DC power and the data from the rectifiers.

### REFERENCE TO RELATED APPLICATION

This application claims the benefit of U.S. Provisional Patent Application No. 60/985,478, filed on Nov. 5, 2007, which is incorporated herein by reference.

### TECHNICAL FIELD

The present invention relates generally to passively powered elements, and in particular to passively powered elements with multiple energy harvesting and communication channels.

### BACKGROUND

Many passively powered devices have been in use for years. These devices are referred to as “passively powered devices” because these devices rely on energy harvesting for power instead of having their own power source (e.g., a battery). Conventionally, a passively powered device includes energy harvesting circuitry in addition to, and separate from, other electronic circuitry (such as communication circuitry). The energy harvesting circuitry receives radiated energy from a remote source (e.g., a reader to communicate with the passively powered device) and converts the radiated energy to electrical energy to power the device.

One major problem with some conventional passively powered devices is the regulatory limits on the amount of energy that can be radiated by radiating sources, such as readers that communicate with the passive element, in both magnitude of energy and bandwidth. Typically, this limit defines a maximum operational range in terms of the physical separation between the passively powered device and the radiating source. Occasionally, the limit defines the amount of time needed to charge the energy harvesting circuitry prior to communication, as the device is unable to communicate until sufficient energy has been harvested. The frequency bands of operations of communication, and of harvested energy, are typically very narrow to prevent electromagnetic interference and corruption of surrounding electrical and electronic products. Under certain circumstances, the physical separation between a reader and a passively powered element may unexpectedly be performing poorly, due to a null in the communications channel or losses in the communications channel. Because of the above limitation on energy that can be harvested, conventional passively powered devices are generally limited in performance, speed, and functionality.

### BRIEF DESCRIPTION OF THE DRAWINGS

The present invention is illustrated by way of example, and not of limitation, in the figures of the accompanying drawings in which:

FIG. 1A illustrates one embodiment of a passively powered element;

FIG. 1B shows one embodiment of a passively powered element with multiple single band antennae, one data receiver, and one data transmitter;

FIG. 1C shows one embodiment of a passively powered element with multiple single band antennae, multiple data receivers, and multiple data transmitters;

FIG. 1D shows one embodiment of a passively powered element with one multi-band/multi-port antenna, one data receiver, and one data transmitter;

FIG. 1E shows one embodiment of a passively powered element with one multi-band/multi-port antenna, multiple data receivers, and multiple data transmitters;

FIG. 1F shows one embodiment of a passively powered element with one multi-band/single-port antenna, one multi-band data receiver, and one multi-band data transmitter;

FIG. 1G shows one embodiment of part of a passively powered element implemented with multiple rectifiers connected in series;

FIG. 1H illustrates one embodiment of part of a passively powered element implemented with multiple rectifiers in parallel;

FIG. 1I illustrates one embodiment of part of a passively powered element implemented with multiple rectifiers connected in series and in parallel;

FIG. 2A illustrates one embodiment of a power conversion and data receiving circuit of a passively powered element;

FIG. 2B shows one embodiment of a 1-stage half wave diode rectifier;

FIG. 2C shows one embodiment of a 2-stage half wave diode rectifier;

FIG. 2D shows one embodiment of a 1-stage full wave diode rectifier;

FIG. 2E shows one embodiment of a 2-stage full wave diode rectifier;

FIG. 2F shows one embodiment of a diode;

FIG. 2G shows another embodiment of a diode;

FIG. 3 illustrates one embodiment of a radio frequency identification (RFID) system;

FIG. 4 illustrates another embodiment of a RFID system; and

FIG. 5 shows one embodiment of a process to passively power an electronic device and to receive data destined to the electronic device.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. It should be noted that the “line” or “lines” discussed herein, that connect elements, may be single lines or multiple lines. It will also be understood by one having ordinary skill in the art that lines and/or other coupling elements may be identified by the nature of the signals they carry (e.g., a “power line” may implicitly carry a “power signal”) and that input and output ports may be identified by the nature of the signals they receive or transmit (e.g., “power input” may implicitly receive a “power signal”).

In some embodiments, a passively powered element includes a number of antennae tuned to receive radio frequency (RF) signals at multiple different frequencies. In other words, the antennae are associated with multiple different channels. The element further includes a number of rectifiers, each coupled to a distinct one of the antennae, to convert energy of the RF signals into direct current (DC) power and to receive data in the RF signals. An electronic device within the element is coupled to the rectifiers to receive the DC power and the data from the rectifiers. As such, the element may take advantage of the multiple channels available for communication to harvest energy (also referred to as “to scavenge energy”) for powering the electronic device. Through the use of multiple channels to harvest energy, more energy may be supplied to the passively powered element. As a result, the passively powered element may achieve higher performance, faster operation, and greater functionality through the use of multiple channels for harvesting energy. More details of various embodiments of the passively powered element are discussed below.

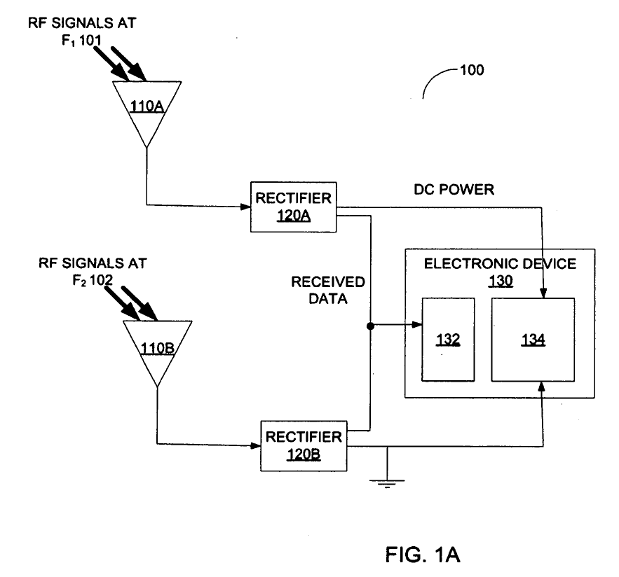

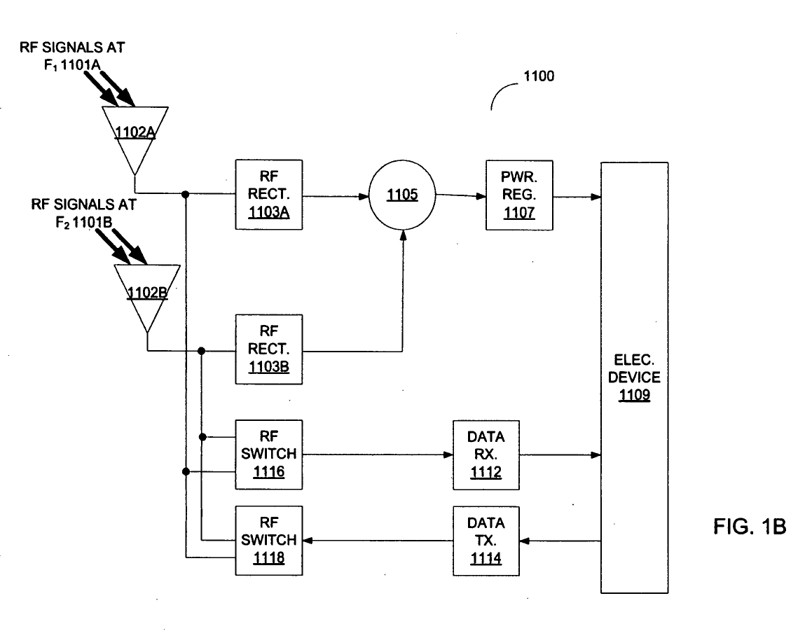

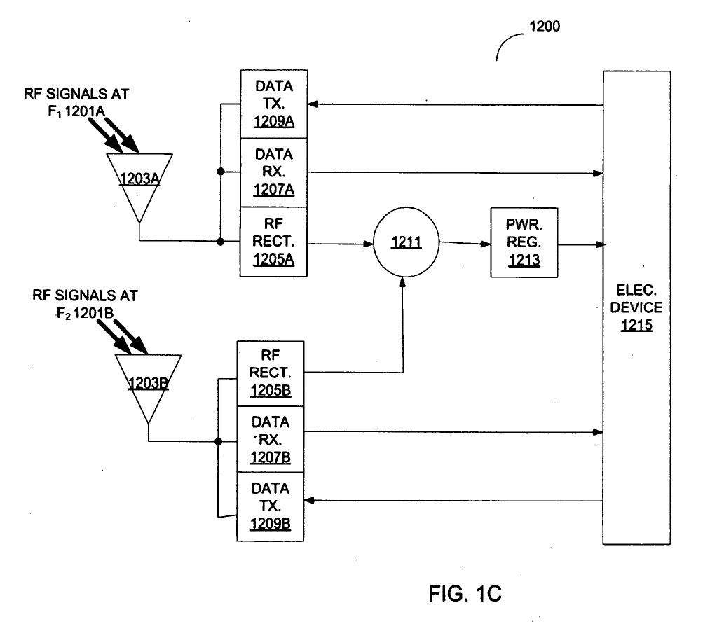

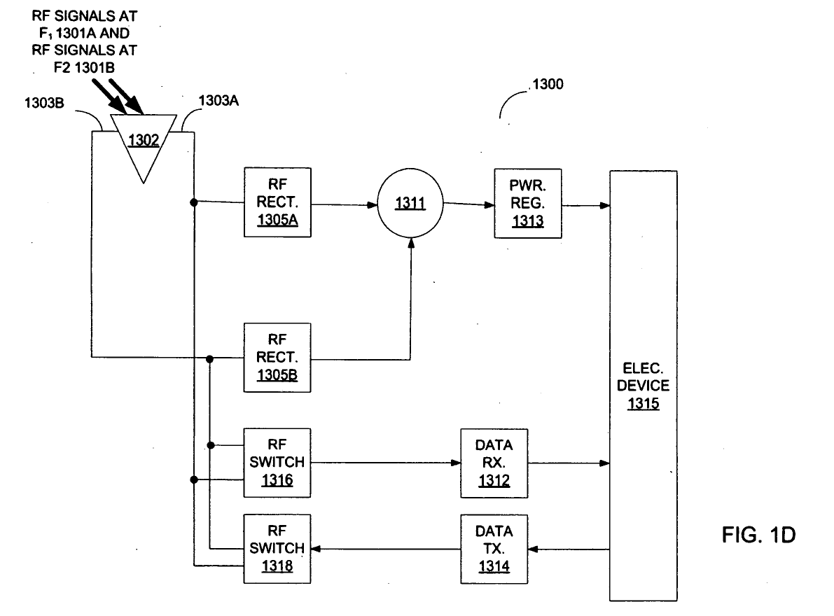

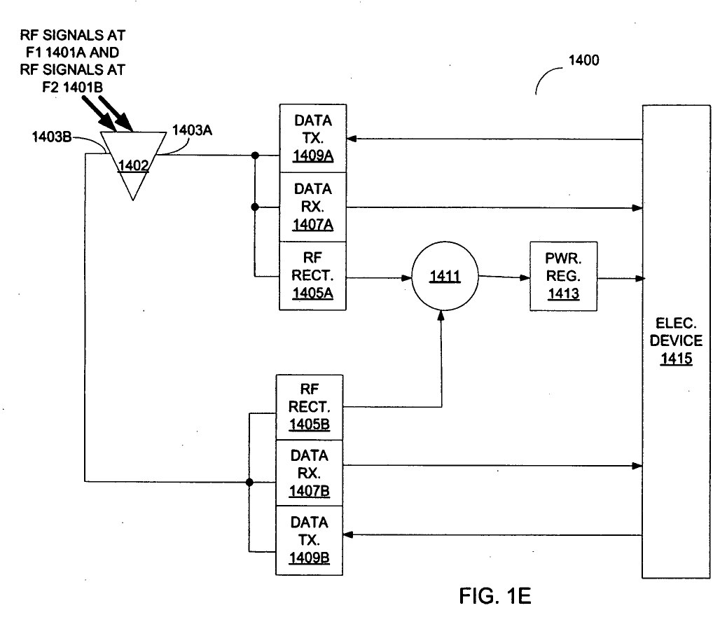

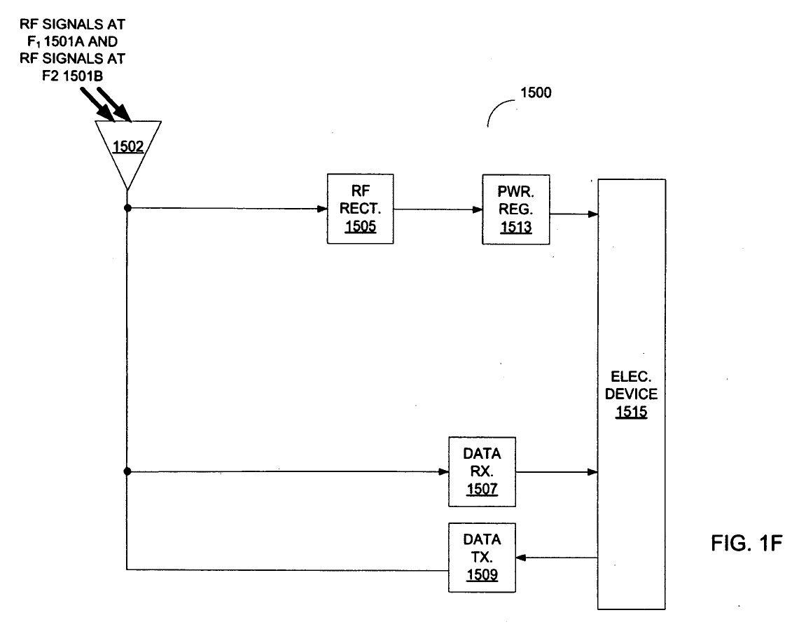

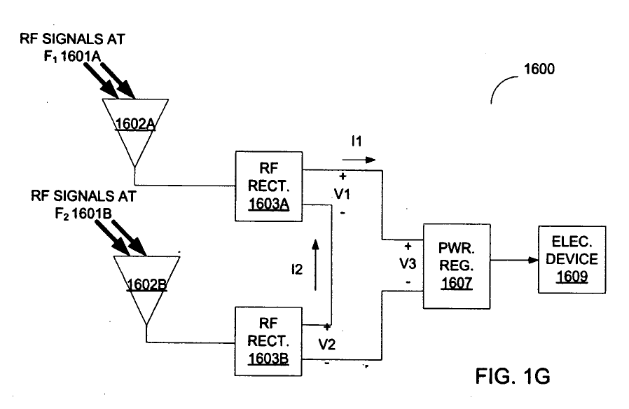

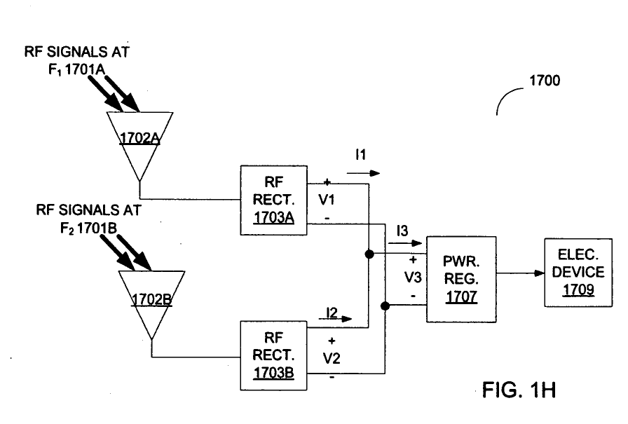

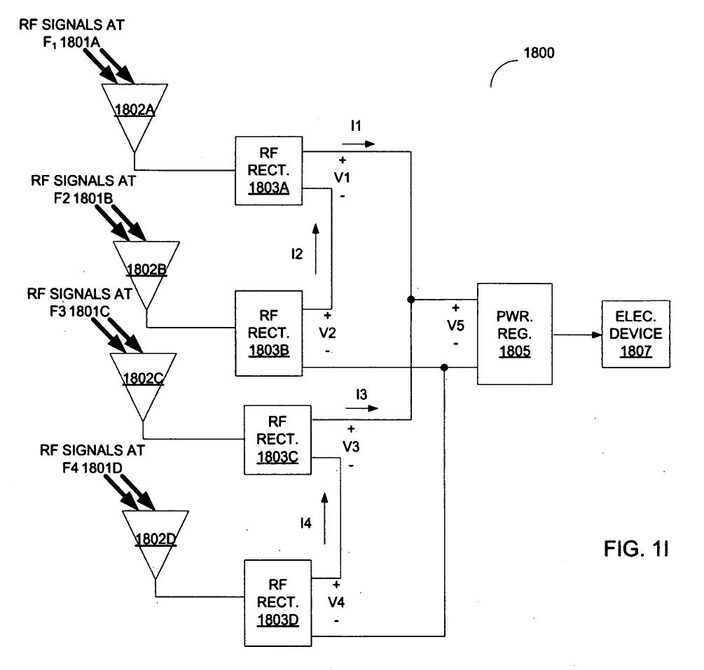

FIG. 1A illustrates one embodiment of a passively powered element. The element 100 includes two antennae 110A and 110B, two rectifiers 120A and 120B, and an electronic device 130. The electronic device 130 further includes a RF data receiver 132 and a power regulation and conversion module 134. The antennae 110A and 110B are coupled to the rectifiers 120A and 120B, respectively. The rectifiers 120A and 120B are further coupled to the electronic device 130.

In some embodiments, the antennae 110A and 110B are tuned to receive RF signals 101 at frequency F1 and RF signals 102 at frequency F2, respectively, where F1 and F2 are distinct from each other. Thus, the antenna 110A is associated with a first channel (also referred to as frequency channel) and the antenna 110B is associated with a second channel. Some examples of the RF signals include interrogation signals from radio frequency identification (RFID) readers, radio signals broadcasted over the air, etc. In other embodiments, the antennae 110A and 110B may receive signals from other energy sources, such as electromagnetic propagation, magnetic fields, mechanical motion, light, heat, acoustic, infra-red (IR) emitters, micro-mechanical system (MEMS), or nanoscale devices, etc. In some embodiments, the total amount of power that can be harvested from N sinusoidal electromagnetic sources may be generally illustrated in a summation form of the Friss transmission equation as shown below:

$${P}_{tot} = {\sum }_{i = 1}^{N} {η}_{i} {p}_{i} {q}_{i} {P}_{{t}_{i}} {G}_{{t}_{i}} {{G}_{{r}_{i}} ( \frac{{λ}_{i}}{4 {π R}_{i}} )}^{2}$$

For simplicity, the current example assumes that there is no interference or interaction between electromagnetic sources and that there is no power loss associated with summing the received power from the electromagnetic sources. The transmission channel for the i^{th} electromagnetic source is characterized by several parameters, including wavelength of the electromagnetic source (λ), transmit power (Pₜ), transmit antenna gain (Gₜ ), receive antenna gain (Gᵣ), distance from transmitter to receiver (R), antenna polarization match (p), antenna impedance match (q), and receiver rectifier efficiency (η).

Depending on the implementation of the electromagnetic sources and the configuration of the passively powered element 100, one or more of the transmission channel parameters may be approximately the same for different electromagnetic sources. For example, if the electromagnetic sources use transmit antennae that are in close proximity to one another relative to the distance between the transmitters and the dual-mode receiver, the channel distance may be approximately the same for all electromagnetic sources.

Referring back to FIG. 1A, the rectifiers 120A and 120B convert energy in the RF signals 101 and 102 into direct current (DC) power and supply the DC power to the electronic device 130. The power regulation and conversion module 134 in the electronic device 130 receives the DC power from the rectifiers 120A and 120B and uses the DC power to power the electronic device 130. In sum, the antennae 110A and 110B receive RF signals to allow energy harvesting at multiple channels for powering the electronic device 130. Note that the channels may operate completely independently of one another, while harvesting a total energy amount greater than available on any single channel as seen in some conventional passively powered devices. Because of the greater energy harvested, the passively powered element 100 may operate in greater ranges, with less latency, and with greater functionality than some conventional passively powered devices.

Furthermore, the rectifiers 120A and 120B also receive data encoded in the RF signals 101 and 102, respectively, and send the received data to the electronic device 130. The RF data receiver 132 in the electronic device 130 receives the data from the rectifiers 120A and 120B and further processes the data. For example, the passively powered element 100 may be implemented inside a RFID tag and the data received may include a request from a passive element reader to retrieve an identification of the RFID tag. In response to the request, the RF data receiver 132 may retrieve the identification from a storage device within the RFID tag and send the identification to the passive element reader. As such, the passively powered element 100 may substantially simultaneously harvest energy from both channels to operate the electronic device 130 and selectively choose one of the two channels for communication.

Although the embodiment illustrated in FIG. 1A has only two antennae to receive RF signals at two distinct frequencies (i.e., F₁ and F₂), it should be apparent to one of ordinary skill in the art that the concept discussed above can be applied to passively powered elements having more antennae tuned to more different frequencies. In other words, the passively powered element 100 has essentially unlimited scalability with respect to communication channels as well as energy harvesting channels.

The passively powered element 100 may switch between channels. This switch may be in response to a command from an external device, through the detection of one or more external stimuli, or in response to the interrogation from a reader (e.g., a RFID reader) on either channel. In some embodiments, semaphore logic is provided in a memory of the passively powered element to prevent corruptions of multiple write or store commands from separate channels.

Note that different types of components and configurations may be used to construct the passively powered element in other embodiments. Some examples of using different types of components and configurations to construct the passively powered element are shown below to illustrate, not to limit, the above concept.

FIG. 1B shows one embodiment of a passively powered element with multiple single band antennae, one data receiver, and one data transmitter. The passively powered element 1100 includes a first single band antenna 1102A tuned to frequency F1 to receive RF signal 1101A at F1, and a second single band antenna 1102B tuned to frequency F2 to receive RF signal 1101B at F2. The first single band antenna 1102A and the second single band antenna 1102B are coupled to the RF rectifiers 1103A and 1103B, respectively. The RF rectifiers 1103A and 1103B rectify the respective RF signals 1101A and 1101B received to convert the RF signals 1101A and 1101B into DC power. Then the RF rectifiers 1103A and 1103B output the DC power to a DC power summer 1105, which sums up the DC power received and forwards the DC power to a power regulator 1107 (such as a voltage regulator). The power regulator 1107 adjusts the power and provides the adjusted power to the electronic device 1109 to power it.

In addition, the passively powered element 1100 further includes a first RF switch 1116 and a second RF switch 1118, each coupled to both antennae 1102A and 1102B. The RF switch 1116 switches between the two antennae 1102A and 1102B to selectively forward RF signals from one of the two antennae 1102A and 1102B to the data receiver 1112. The data receiver 1112 then sends data encoded in the selected RF signals to the electronic device 1109 for further processing. Likewise, the RF switch 1118 switches between the two antennae 1102A and 1102B to selectively forward data signals from the data transmitter 1114 to one of the two antennae 1102A and 1102B to be transmitted. The data transmitter 1114 receives the data signals from the electronic device 1109.

FIG. 1C shows one embodiment of a passively powered element with multiple single band antennae, multiple data receivers, and multiple data transmitters. The passively powered element 1200 includes a first single band antenna 1203A tuned to frequency F1 to receive RF signal 1201A at F1, and a second single band antenna 1203B tuned to frequency F2 to receive RF signal 1201B at F2. The first single band antenna 1203A and the second single band antenna 1203B are coupled to the RF rectifiers 1205A and 1205B, respectively. The RF rectifiers 1205A and 1205B rectify the respective RF signals 1201A and 1201B received to convert the RF signals 1201A and 1201B into DC power. Then the RF rectifiers 1205A and 1205B output the DC power to a DC power summer 1211, which sums up the DC power received and forwards the DC power to a power regulator 1213 (such as a voltage regulator). The power regulator 1213 adjusts the power and provides the adjusted power to the electronic device 1215 to power it.

In addition, the passively powered element 1200 further includes a first data receiver 1207A and a second data receiver 1207B coupled to the antennae 1203A and 1203B, respectively, to receive data encoded in the RF signals 1201A and 1201B, respectively. Then the data receivers 1207A and 1207B send the data to the electronic device 1215. Likewise, the passively powered element 1200 further includes a first data transmitter 1209A and a second data transmitter 1209B coupled to the antennae 1203A and 1203B, respectively, to transmit data from the electronic device 1215 to the antennae 1203A and 1203B, respectively. The antennae 1203A and 1203B then transmits the data in the RF signals 1201A and 1201B, respectively.

FIG. 1D shows one embodiment of a passively powered element with one multi-band/multi-port antenna, one data receiver, and one data transmitter. Specifically, the passively powered element 1300 includes a multi-band/multi-port antenna 1302 having a first antenna port 1303A for frequency F1 and a second antenna port 1303B for frequency F2. The multi-band/multi-port antenna 1302 is tuned to receive RF signals 1301A at F1 and RF signals 1301B at F2. The antenna ports 1303A and 1303B are coupled to RF rectifiers 1305A and 1305B, respectively. The RF rectifiers 1305A and 1305B rectify the respective RF signals 1301A and 1301B received to convert the RF signals 1301A and 1301B into DC power. Then the RF rectifiers 1305A and 1305B output the DC power to a DC power summer 1311, which sums up the DC power received and forwards the DC power to a power regulator 1313 (such as a voltage regulator). The power regulator 1313 adjusts the power and provides the adjusted power to the electronic device 1315 to power it.

In addition, the passively powered element 1300 further includes a first RF switch 1316 and a second RF switch 1318, each coupled to both antenna ports 1303A and 1303B. The RF switch 1316 switches between the two antenna ports 1303A and 1303B to selectively forward RF signals from one of the two antenna ports 1303A and 1303B to the data receiver 1312. The data receiver 1312 then sends data encoded in the selected RF signals to the electronic device 1315 for further processing. Likewise, the RF switch 1318 switches between the two antenna ports 1303A and 1303B to selectively forward data signals from the data transmitter 1314 to one of the two antennae 1302A and 1302B to be transmitted. The data transmitter 1314 receives the data signals from the electronic device 1315.

FIG. 1E shows one embodiment of a passively powered element with one multi-band/multi-port antenna, multiple data receivers, and multiple data transmitters. The passively powered element 1400 includes a multi-band/multi-port antenna 1402 having a first antenna port 1403A for frequency F1 and a second antenna port 1403B for frequency F2. The multi-band/multi-port antenna 1402 is tuned to receive RF signals 1401A at F1 and RF signals 1401B at F2. The antenna ports 1403A and 1403B are coupled to RF rectifiers 1405A and 1405B, respectively. The RF rectifiers 1405A and 1405B rectify the respective RF signals 1401A and 1401B received to convert the RF signals 1401A and 1401B into DC power. Then the RF rectifiers 1405A and 1405B output the DC power to a DC power summer 1411, which sums up the DC power received and forward the DC power to a power regulator 1413 (such as a voltage regulator). The power regulator 1413 adjusts the power and provides the adjusted power to the electronic device 1415 to power it.

In addition, the passively powered element 1400 further includes a first data receiver 1407A and a second data receiver 1407B coupled to the antenna ports 1403A and 1403B, respectively, to receive data encoded in the RF signals 1401A and 1401B, respectively. Then the data receivers 1407A and 1407B send the data to the electronic device 1415. Likewise, the passively powered element 1400 further includes a first data transmitter 1409A and a second data transmitter 1409B coupled to the antenna ports 1403A and 1403B, respectively, to transmit data from the electronic device 1415 to the antenna ports 1403A and 1403B, respectively. The antenna 1402 then transmits the data in the RF signals 1401A and 1401B at their respective frequencies.

FIG. 1F shows one embodiment of a passively powered element with one multi-band/single-port antenna, multiple data receivers, and multiple data transmitters. The passively powered element 1500 includes a multi-band/single-port antenna 1502 tuned to receive RF signals 1501A at frequency F1 and RF signals 1501B at frequency F2. The multi-band/single-port antenna 1502 is coupled to a RF rectifier 1505 for both F1 and F2. The RF rectifier 1505 converts the RF signals 1501A and 1501B into DC power and sends the DC power to a power regulator 1513 (such as a voltage regulator). The power regulator 1513 adjusts the DC power and provides the adjusted DC power to an electronic device 1515 to power it.

In addition, the passively powered element 1500 further includes a data receiver 1507 and a data transmitter 1509, both coupled to the multi-band/single-port antenna 1502. The data receiver 1507 receives RF signals 1501A and 1501B from the multi-band/single-port antenna 1502 and sends the data encoded in the RF signals 1501A and 1501B to the electronic device 1515 for further processing. The data transmitter 1509 receives data from the electronic device 1515 and encodes the data into RF signals 1501A and 1501B, which are sent to the antenna 1502 to be transmitted.

FIG. 1G shows another embodiment of a passively powered element. The passively powered element 1600 includes a first single band antenna 1602A tuned to frequency F1 to receive RF signal 1601A at F1, and a second single band antenna 1602B tuned to frequency F2 to receive RF signal 1601B at F2. The first single band antenna 1602A and the second single band antenna 1602B are coupled to the RF rectifiers 1603A and 1603B, respectively. The RF rectifiers 1603A and 1603B are coupled to each other in series such that a current I2 flowing out of the RF rectifier 1603B flows into RF rectifier 1603A. The RF rectifiers 1603A and 1603B rectify the respective RF signals 1601A and 1601B received to convert the RF signals 1601A and 1601B into DC power. The output voltage V1 from RF rectifier 1603A and the output voltage V2 from RF rectifier 1603B are added together to input to the power regulator 1607 as V3 (i.e., V3=V1+V2). The output currents of the RF rectifiers 1603A and 1603B (I1 and I2, respectively) and the input current I3 to the power regulator 1607 are the same. The power regulator 1607 adjusts the power and provides the adjusted power to the electronic device 1609 to power it.

FIG. 1H illustrates one embodiment of part of a passively powered element implemented with multiple rectifiers in parallel. The passively powered element 1700 includes a first antenna 1702A tuned to frequency F1 to receive RF signals 1701A and a second antenna 1702B tuned to frequency F2 to receive RF signals 1701B. The antennae 1702A and 1702B are coupled to a first RF rectifier 1703A and a second RF rectifier 1703B, respectively. The RF rectifiers 1703A and 1703B are further coupled to a power regulator 1707. The RF rectifiers 1703A and 1703B are coupled to each other in parallel. The RF rectifiers 1703A and 1703B convert the RF signals 1071A and 1701B into DC signals and output DC current I1 and DC current I2, respectively, to the power regulator 1707. As such, a current I3, which is the sum of I1 and I2, is input to the power regulator 1707. Each of the output voltages of RF rectifiers 1703A and 1703B (i.e., V1 and V2, respectively) is about equal to the input voltage V3 of the power regulator 1707.

The RF rectifiers 1703A and 1703B are further coupled to a power regulator 1707, which adjusts the DC power from the RF rectifiers 1703A and 1703B and provides the DC power adjusted to the electronic device 1709.

FIG. 1I illustrates one embodiment of part of a passively powered element implemented with multiple rectifiers connected in series and in parallel. The passively powered element 1800 includes four antennae 1802A, 1802B, 1802C, and 1802D tuned to frequencies F1, F2, F3, and F4, respectively, to receive RF signals 1801A, 1801B, 1801C, and 1801D, respectively. The antennae 1802A, 1802B, 1802C, and 1802D are coupled to RF rectifiers 1803A, 1803B, 1803C, and 1803D, respectively.

The RF rectifiers 1803A and 1803B are coupled to each other in series. As such the output currents I1 and I2 of the RF rectifiers 1803A and 1803B, respectively, are substantially the same. Likewise, the RF rectifiers 1803C and 1803D are coupled to each other in series. As such the output currents I3 and I4 of the RF rectifiers 1803C and 1803D, respectively, are substantially the same. Furthermore, the series of RF rectifiers 1803A and 1803B and the series of RF rectifiers 1803C and 1803D are coupled to a power regulator 1805 in parallel. As such, the input current I5 to the power regulator 1805 is the sum of I1 and I3. The input voltage V5 to the power regulator 1805 is equal to the sum of the output voltages of RF rectifiers 1803A and 1803B, namely, V1 and V2, respectively (i.e., V5=V1+V2). Likewise, the input voltage V5 is also equal to the sum of the output voltages of RF rectifiers 1803C and 1803D, namely V3 and V4, respectively (i.e., V5=V3+V4).

The RF rectifiers 1803A, 1803B, 1803C, and 1803D convert the RF signals 1801A, 1801B, 1801C, and 1801D, respectively, into DC power and send the DC power to a power regulator 1805 (such as a voltage regulator). The power regulator 1805 adjusts the DC power and provides the DC power to the electronic device 1807.

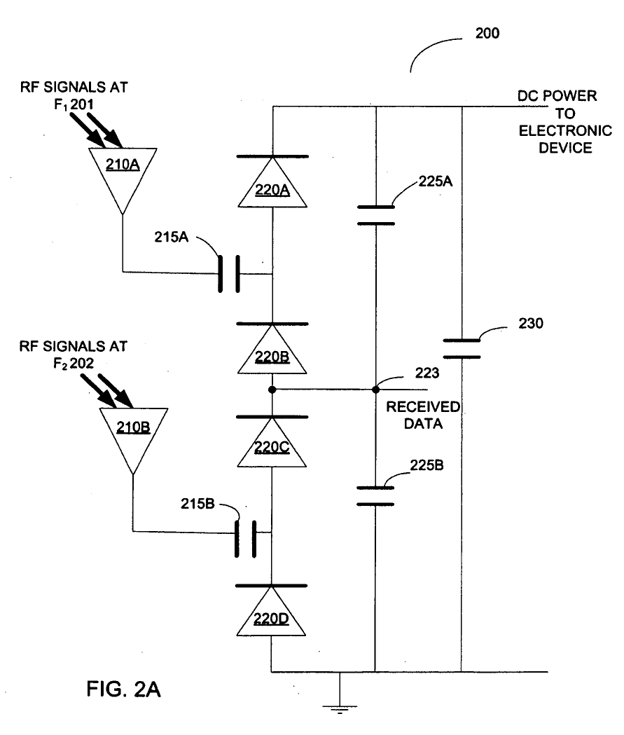

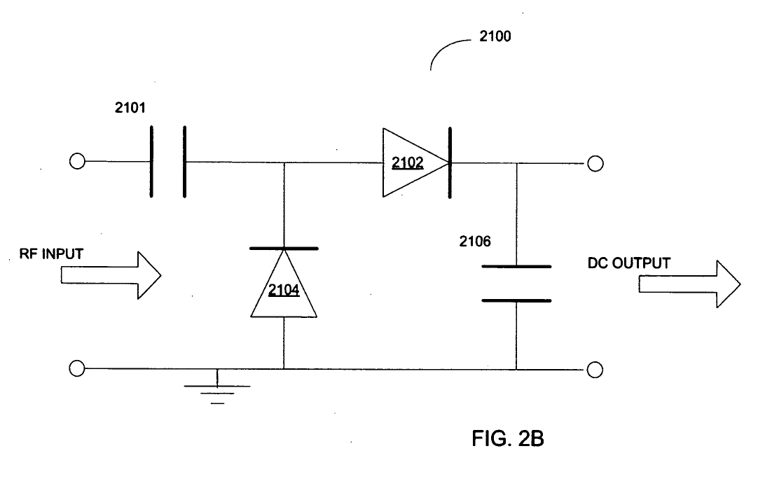

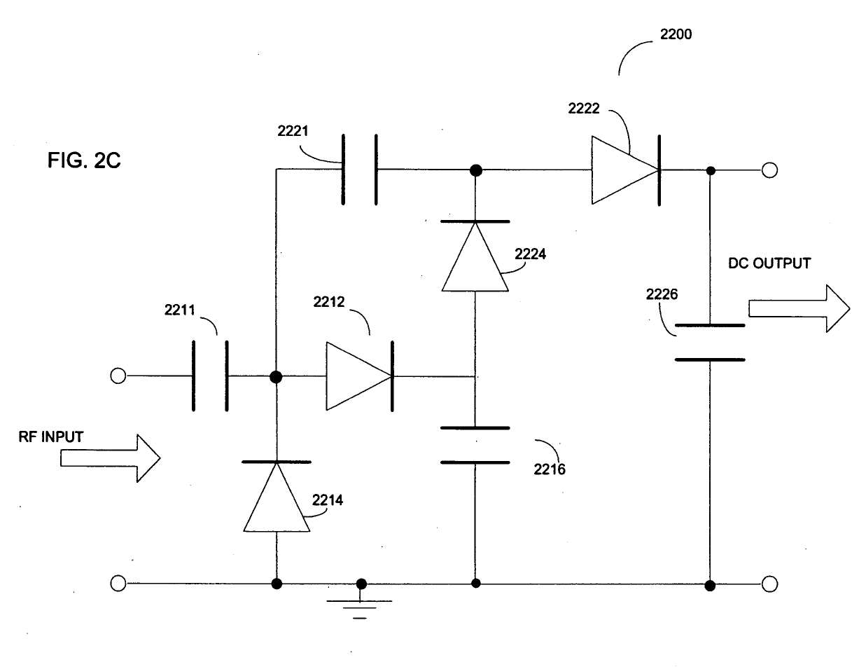

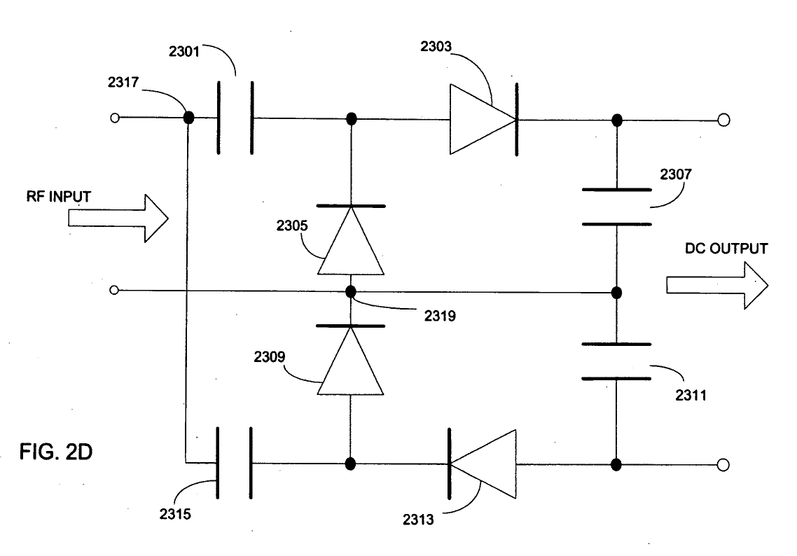

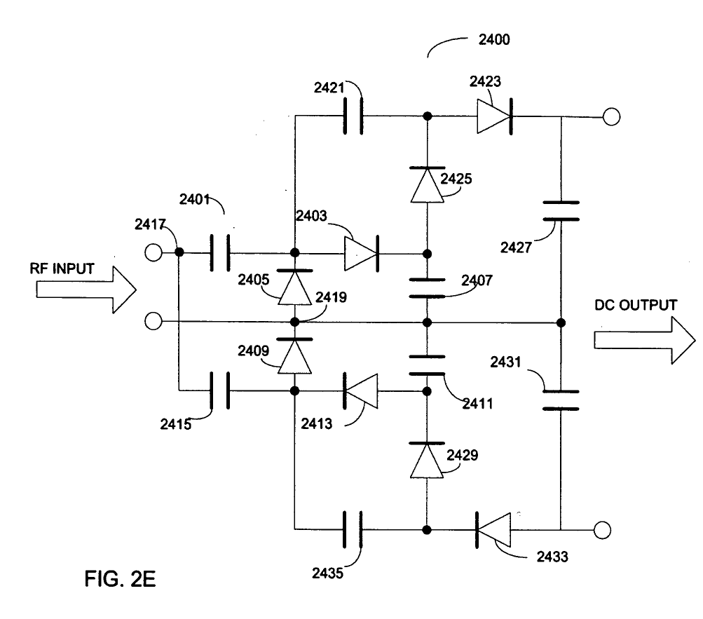

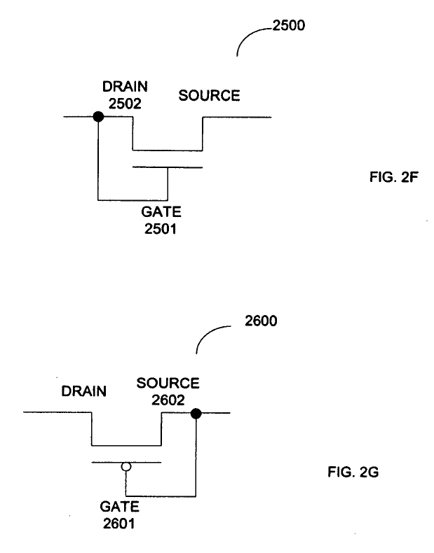

FIG. 2A illustrates one embodiment of a power conversion and data receiving circuit usable in a passively powered element, such as the passively powered element 100 shown in FIG. 1A. Referring to FIG. 2A, the power conversion and data receiving circuit 200 includes two antennae 210A and 210B, five capacitors 215A, 215B, 225A, 225B, and 230, and four diodes 220A-220D. The antennae 210A and 210B are coupled to the capacitors 215A and 215B, respectively. The anode of the diode 220A and the cathode of the diode 220B are coupled to the capacitor 215A. The cathode of the diode 220C is coupled to the anode of the diode 220B. Likewise, the cathode of the diode 220D is coupled to the anode of the diode 220C. The cathode of the diode 220D and the anode of the diode 220C are also coupled to the capacitor 215B. The anode of the diode 220D and the cathode of the diode 220A are coupled to the capacitors 225B and 225A, respectively. Likewise, the anode of the diode 220B is coupled to the capacitor 225A, and the cathode of the diode 225C is coupled to capacitor 225B. Capacitors 225A and 225B are coupled together. The anode of the diode 220D and the cathode of the diode 220A are further coupled to the capacitor 230, which is coupled to the capacitors 225A and 225B in parallel.

In some embodiments, the antennae 210A and 210B are tuned to frequencies F₁ and F₂, respectively, to receive RF signals 201 and 202, respectively. The capacitors 215A and 215B store energy of the RF signals 201 and 202, respectively. When the capacitors 215A and 215B have been charged to a predetermined level, currents are generated to flow to the diodes 220A-220D. The diodes 220A-220D allow currents to flow through them from their respective anodes to their respective cathodes only. In other words, the currents may flow through the diodes 220A-220D in one direction only. The diodes 220A-220D, which are connected in series, add the currents from the capacitors 215A and 215B to output a DC current at the anode of the diode 220A. As such, the diodes 220A-220D convert the current from the capacitors 215A and 215B into DC power. The DC power may be supplied to an electronic device (such as the electronic device 130 in FIG. 1A) to power the electronic device. In some embodiments, the DC power from the diodes 220A-220D may accumulate in the capacitor 230 in order to stabilize the power supply to the electronic device. Alternatively, the DC power from the diodes 220A-220D may be stored in one or more other energy storage devices, such as an inductor, a battery, etc.

In addition to converting energy in the RF signals 201 and 202 into DC power, the power conversion and data receiving circuit 200 receives data encoded in the RF signals 201 and 202. By charging the capacitors 225A and 225B with the DC current from the diodes 220A-220D, the data encoded in the RF signals 201 and 202 may be received at a node 223 between the capacitors 225A and 225B. The data received may be forwarded to the electronic device for further processing. As mentioned above, the electronic device and the power conversion and data receiving circuit 200 usable in an RFID tag communicably coupled to one or more RFID readers in a RFID system. Some embodiments of a RFID system are discussed in details below.

Note that the RF rectifiers used in various embodiments of a passively powered device may be implemented with different components in different configurations. Some examples of RF rectifiers are discussed in details below. FIG. 2B shows one embodiment of a 1-stage half wave diode rectifier 2100, which is also referred to as a “doubler.” The rectifier 2100 includes a capacitor 2101 coupled to the anode of the diode 2102 and the cathode of the diode 2104. The anode of the diode 2104 is coupled to ground. The cathode of the diode 2102 is coupled to another capacitor 2106. RF signals are input to the rectifier 2100 via the capacitor 2101 and the voltage across the capacitor 2106 is taken as the output voltage of the rectifier 2100.

FIG. 2C shows one embodiment of a 2-stage half wave diode rectifier 2200, which is also referred to as a “quadruple r.” The rectifier 2200 includes two stages. Like the 1-stage half wave diode rectifier 2100 shown in FIG. 2B, the first stage includes a capacitor 2211, two diodes 2212 and 2214, and another capacitor 2216, coupled to each other in substantially the same way as the 1-stage half wave diode rectifier 2100. The second stage includes a capacitor 2221, two diodes 2222 and 2224, and another capacitor 2226. The capacitor 2221 is coupled between the anode of diode 2212 and the cathode of diode 2224. The anode of cathode 2224 is further coupled to the anode of the diode 2222. The anode of the diode 2224 is coupled to the cathode of the diode 2212. The cathode of the diode 2222 is coupled to the capacitor 2226, which is further coupled to ground. RF signals are input to the rectifier 2200 via the capacitor 2211 and the voltage across the capacitor 2226 is taken as the output voltage of the rectifier 2200.

FIG. 2D shows one embodiment of a 1-stage full wave diode rectifier. The rectifier 2300 includes four capacitors 2301, 2307, 2311, and 2315 and four diodes 2303, 2305, 2309, and 2313. Capacitor 2301 is coupled between node 2317 and the cathode of diode 2305 and the anode of diode 2303. The cathode of diode 2303 is further coupled to capacitor 2307. The other end of capacitor 2307 is coupled to the anode of diode 2305, the cathode of diode 2309, and another capacitor 2311 at node 2319. The anode of diode 2309 is coupled to capacitor 2315 and the cathode of diode 2313. The other end of capacitor 2315 is coupled to capacitor 2301. The anode of diode 2313 is coupled to capacitor 2311. RF signals are input to the rectifier 2300 via nodes 2317 and 2319 and rectified, and the DC voltage across capacitors 2307 and 2311 is taken as the DC output voltage.

FIG. 2E shows one embodiment of a 2-stage full wave diode rectifier. The rectifier 2400 includes two stages. The first stage includes four capacitors 2401, 2407, 2411, and 2415 and four diodes 2403, 2405, 2409, and 2413, which are connected to each other in substantially the same way as in the 1-stage full wave diode rectifier 2300 shown in FIG. 2D. The second stage of the rectifier 2400 also includes four diodes 2425, 2423, 2433, and 2429 and four capacitors 2421, 2427, 2431, and 2435. Capacitor 2421 is coupled between the cathode of diode 2405 and the anode of diode 2423. The anode of diode 2423 is further coupled to the cathode of diode 2425. The anode of diode 2425 is coupled to the cathode of diode 2403. The cathode of diode 2423 is coupled to one end of capacitor 2427, and the other end of capacitor 2427 is coupled to node 2419. One end of capacitor 2431 is also coupled to node 2419, and the other end of capacitor 2431 is coupled to the anode of diode 2433. The cathode of diode 2433 is coupled to the anode of diode 2429 and one end of capacitor 2435. The other end of capacitor 2435 is coupled to the cathode of diode 2413. RF signals are input to the rectifier 2400 via nodes 2417 and 2419 and rectified, and the DC voltage across capacitors 2427 and 2431 is taken as the DC output voltage.

In some embodiments, the diodes in the RF rectifiers may be replaced with transistors as shown in FIGS. 2F and 2G. Referring to FIG. 2F, a gate 2501 of an n-type metal oxide silicon (nMOS) transistor is connected to a drain 2502 of the nMOS 2500 to form a diode (which may be referred to as the effective diode). Referring to FIG. 2G, a gate 2601 of a p-type metal oxide silicon (pMOS) transistor is connected to a source 2602 of the pMOS 2600 to form a diode (which may be referred to as the effective diode). The transistors 2500 and 2600 have a low threshold voltage to reduce the forward voltage drop of the effective diode.

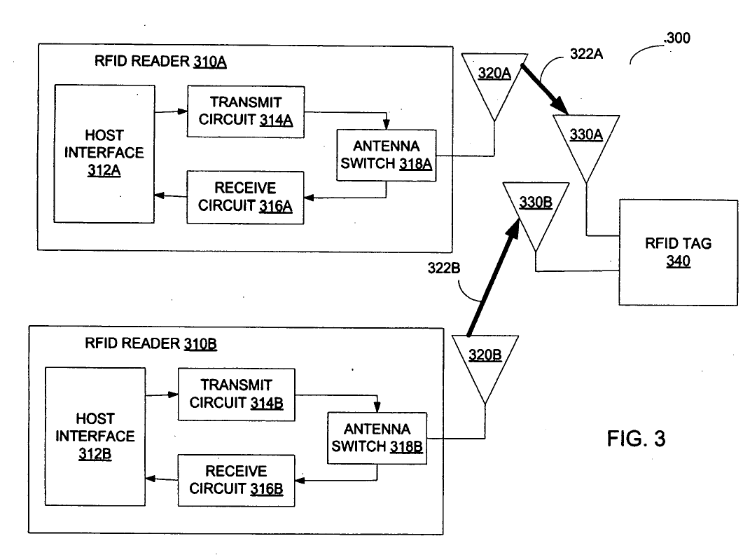

FIG. 3 illustrates one embodiment of a RFID system. The system 300 includes two RFID readers 310A and 310B and a RFID tag 340. Note that the system 300 may include additional RFID tags, some of which may be substantially similar to the RFID tag 340, in some embodiments. The RFID tag 340 includes a power conversion, data receiving, and data transmitting circuit. Details of some embodiments of the power conversion, data receiving, and data transmitting circuit have been discussed above. Each of the RFID readers 310A and 310B is associated with a single channel. The RFID reader 310A includes a host interface 312A, a transmit circuit 314A, a receive circuit 316A, an antenna switch 318A, and an antenna 320A. Likewise, the RFID reader 310B includes a host interface 312B, a transmit circuit 314B, a receive circuit 316B, an antenna switch 318B, and an antenna 320B. The antennae 320A and 320B are tuned to a first and a second predetermined frequencies, respectively, to transmit and to receive RF signals 322A at the first predetermined frequency and RF signals 322B at the second predetermined frequency. The RFID tag 340 includes two antennae 330A and 330B, which are also tuned to the first and second predetermined frequencies, respectively, to transmit and to receive RF signals 322A at the first predetermined frequency and RF signals 322B at the second predetermined frequency. Thus, the RFID readers 310A and 310B are wirelessly communicably coupled to the RFID tag 340.

In some embodiments, the RFID reader 310A may interface with other computing devices (such as computers used in security maintenance, inventory tracking, etc.) via the host interface 312A. When the host interface 312A receives a request to transmit data (e.g., a request for identification, an authentication code, etc.) to the RFID tag 340, the host interface 312A sends the data and one or more control signals to the transmit circuit 314A. In response, the transmit circuit 314A instructs the antenna switch 318A to go into transmission mode to transmit RF signals 322A encoded with the data via the antenna 320A to the RFID tag 340. The RFID tag 340 receives the RF signals 322A via the antenna 330A. Likewise, the other RFID reader 310B may transmit RF signals 322B, in response to a request from another computing device, to the RFID tag 340 in substantially similar manner.

When the antenna 320A receives RF signals (which may be from the antenna 330A of the RFID tag 340, or from another RFID tag), the antenna switch 318A goes into receiving mode to forward the RF signals received at the antenna 320A to the receive circuit 316A. The receive circuit 316A may convert the RF signals received into electrical signals and forward the electrical signals to the host interface 312A. The host interface 312A may forward the electrical signals to other computing devices for further processing. For example, the data may include an identification of the RFID tag 340 and the other computing device may attempt to authenticate the identification. Likewise, the RFID reader 310B may operate in substantially the same way as described above with respect to the RFID reader 310A to receive RF signals from the RFID tag 340.

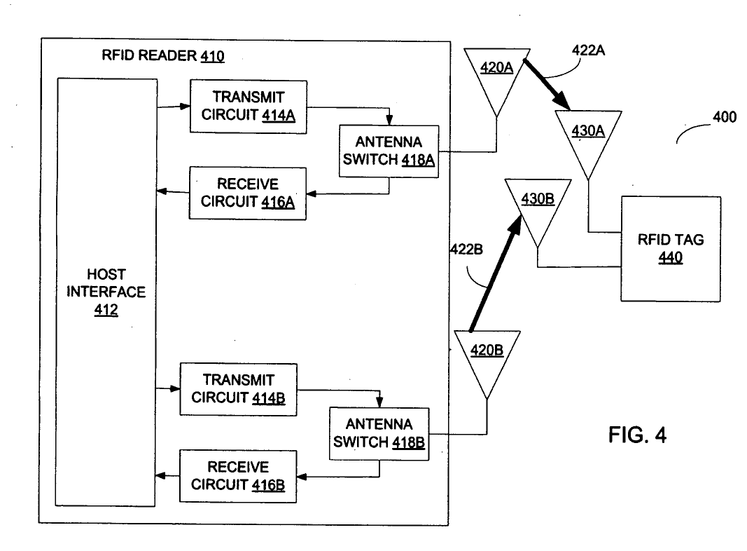

FIG. 4 illustrates another embodiment of a RFID system. The system 400 includes one RFID reader 410 and a RFID tag 440. Note that the system 400 may further include additional RFID tags, some of which may be substantially similar to the RFID tag 440, in some embodiments. The RFID tag 440 includes a power conversion, data receiving, and data transmitting circuit. Details of some embodiments of the power conversion, data receiving, and data transmitting circuit have been discussed above. Unlike the RFID readers 310A and 310B illustrated in FIG. 3 above, each of which supports only one channel, the RFID reader 410 supports multiple channels.

The RFID reader 410 includes a host interface 412, transmit circuits 414A and 414B, receive circuits 416A and 416B, antenna switches 418A and 418B, and antennae 420A and 420B. The transmit circuits 414A and 414B and the receive circuits 416A and 416B are coupled to the host interface 412. Via the host interface, the RFID reader 410 may be coupled to other computing devices, such as computers used in security maintenance, inventory tracking, etc. The transmit circuit 414A and the receive circuit 416A are coupled to the antenna switch 418A. Likewise, the transmit circuit 414B and the receive circuit 416B are coupled to the antenna switch 418B. The antenna switches 418A and 418B are coupled to the antennae 420A and 420B, respectively. It should be apparent that the RFID reader 410 may include more than two groups of antennae, antenna switch, transmit circuit, and receive circuit coupled to the host interface 412 in other embodiments.

In some embodiments, the host interface 412 receives requests to transmit data (e.g., a request for identification, an authentication code, etc.) to the RFID tag 440 from other computing devices coupled to the RFID reader 410. In response, the host interface 412 sends the data and one or more control signals to the transmit circuits 414A and 414B. The transmit circuits 414A and 414B instruct the antenna switch 418A and 418B, respectively, to go into transmission mode to transmit RF signals 422A and 422B encoded with the data via the antennae 420A and 420B, respectively, to the RFID tag 440. The RFID tag 440 receives the RF signals 422A and 422B via the antennae 430A and 430B, respectively.

When the antenna 420A receives RF signals (which may be from the antenna 430A of the RFID tag 440, or from another RFID tag), the antenna switch 418A goes into receiving mode to forward the RF signals received to the receive circuit 416A. The receive circuit 416A may convert the RF signals received into analog and/or digital signals and forward the analog and/or digital signals to the host interface 412A. The host interface 412 may forward the analog and/or digital signals to other computing devices for further processing. For example, the data may include an identification of the RFID tag 440 and the other computing device may authenticate the identification. Likewise, the antenna 420B, antenna switch 418B, and the receive circuit 416B may operate in substantially the same way as described above when the antenna 420B receives RF signals.

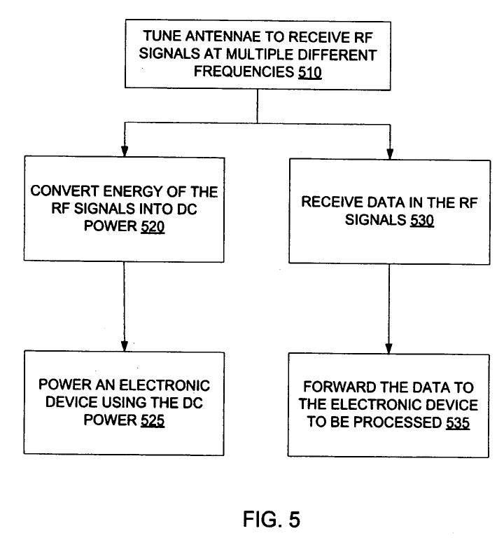

FIG. 5 illustrates one embodiment of a process to passively power an electronic device and to receive data destined to the electronic device substantially simultaneously. The process may be performed by various embodiments of a passively powered element (such as the passively powered element 100 illustrated in FIG. 1A).

Referring to FIG. 5, a number of antennae in a passively powered element (such as a RFID tag) are tuned to receive RF signals at multiple different frequencies (processing block 510). For example, each antenna may be tuned to a distinct one of the frequencies. Alternatively, two or more of the antennae may be tuned to the same frequencies. Then the energy of the RF signals is converted into DC power (processing block 520) to power an electronic device within the passively powered element (processing block 525). At the same time, data encoded in the RF signals is also received by the passively powered element (processing block 530). The data received is forwarded to the electronic device to be further processed (processing block 535).

Thus, some embodiments of a passively powered element and some embodiments of a system incorporating a passively powered element have been described. It will be apparent from the foregoing description that aspects of the present invention may be embodied, at least in part, in software. That is, the techniques may be carried out in a computer system or other data processing system in response to its processor, executing sequences of instructions contained in a memory. In various embodiments, hardwired circuitry may be used in combination with software instructions to implement the present invention. Thus, the techniques are not limited to any specific combination of hardware circuitry and software or to any particular source for the instructions executed by the data processing system. In addition, throughout this description, various functions and operations may be described as being performed by or caused by software code to simplify description. However, those skilled in the art will recognize what is meant by such expressions is that the functions result from execution of the code by a processor or controller.

A computer readable medium can be used to store software and data which when executed by a data processing system causes the system to perform various methods of the present invention. This executable software and data may be stored in various places including, for example, programmable memory or any other device that is capable of storing software programs and/or data. Thus, a computer readable medium includes any mechanism that provides (i.e., stores and/or transmits) information in a form accessible by a machine (e.g., a computer, network device, personal digital assistant, manufacturing tool, any device with a set of one or more processors, etc.). For example, a computer readable medium includes recordable/non-recordable media (e.g., read only memory (ROM); random access memory (RAM); magnetic disk storage media; optical storage media; flash memory devices; etc.); etc.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. An apparatus comprising:
a plurality of antennae tuned to transmit and to receive radio frequency (RF) signals at a plurality of frequencies;
a plurality of power rectifying and communication circuits, each of the plurality of power rectifying and communication circuits coupled to a distinct one of the plurality of antennae, to convert energy of the RF signals into direct current (DC) power and to receive data in the RF signals; and
an electronic device coupled to the plurality of power rectifying and communication circuits, the electronic device to receive the DC power and the data from the plurality of power rectifying and communication circuits.

2. The apparatus of claim 1, wherein each of the plurality of power rectifying and communication circuits comprises:
a first capacitor having a first end and a second end, the first end coupled to one of the plurality of antennae;
a first diode having a first anode and a first cathode, the first cathode of the first diode coupled to the second end of the first capacitor; and
a second diode having a second anode and a second cathode, the second anode of the second diode coupled to the second end of the first capacitor and the first cathode of the first diode.

3. The apparatus of claim 2, wherein each of the plurality of power rectifying and communication circuits further comprises:
a second capacitor having a first end and a second end, the first end coupled to the first anode of the first diode, and the second end coupled to the first cathode of the second diode, wherein the second end outputs the data received in the RF signals.

4. The apparatus of claim 3, further comprising:
an energy storage device coupled between the plurality of power rectifying and communication circuits and a ground, wherein the energy storage device is further coupled to the electronic device.

5. The apparatus of claim 4, wherein the energy storage device includes a third capacitor.

6. The apparatus of claim 4, wherein the energy storage device includes an inductor.

7. The apparatus of claim 4, wherein the energy storage device includes a battery.

8. The apparatus of claim 1, wherein each of the plurality of power rectifying and communication circuits comprises
a data receiver to receive data in the RF signals;
a data transmitter to transmit data in the RF signals; and
a rectifier to rectify the RF signals into DC signals.

9. The apparatus of claim 1, wherein the electronic device comprises:
a RF data receiver to receive the data from the plurality of power rectifying and communication circuits; and
a power regulation and conversion module to receive the DC power from the plurality of power rectifying and communication circuits and to use the DC power received to power the electronic device.

10. A system comprising:
a passive element reader; and
a passively powered element communicably coupled to the passive element reader, the passively powered element comprising:
a plurality of antennae tuned to transmit and to receive radio frequency (RF) signals at a plurality of frequencies from the passive element reader;
a plurality of power rectifying and communication circuits, each of the plurality of power rectifying and communication circuits coupled to a distinct one of the plurality of antennae, to convert energy of the RF signals into direct current (DC) power, to receive data in the RF signals, and to transmit data in the RF signals; and
an electronic device coupled to the plurality of power rectifying and communication circuits, the electronic device to receive the DC power and the data from the plurality of power rectifying and communication circuits.

11. The system of claim 10, wherein the passive element reader comprises:
a plurality of signal transmission modules; and
a host interface coupled to the plurality of signal transmission modules.

12. The system of claim 11, wherein each of the plurality of signal transmission modules comprises:
an antenna to transmit a portion of the RF signals at a distinct one of the plurality of frequencies;
an antenna switch coupled to the antenna;
a transmit circuit coupled between the antenna switch and the host interface; and
a receive circuit coupled between the antenna switch and the host interface, wherein the antenna switch selects between the transmit circuit and the receive circuit.

13. The system of claim 11, wherein each of the plurality of signal transmission modules comprises:
a transmit antenna to transmit a portion of the RF signals at a distinct one of the plurality of frequencies;
a transmit circuit coupled between the transmit antenna and the host interface;
a receive antenna to receive RF signals at one of the plurality of frequencies; and
a receive circuit coupled between the receive antenna and the host interface.

14. A system comprising:
a plurality of passive element readers; and
a passively powered element communicably coupled to the plurality of passive element readers, the passively powered element comprising:
a plurality of antennae tuned to transmit and to receive radio frequency (RF) signals at a plurality of frequencies from the passive element reader;
a plurality of power rectifying and communication circuits, each of the plurality of power rectifying and communication circuits coupled to a distinct one of the plurality of antennae, to convert energy of the RF signals into direct current (DC) power, to receive data in the RF signals, and to transmit data in the RF signals; and
an electronic device coupled to the plurality of power rectifying and communication circuits, the electronic device to receive the DC power and the data from the plurality of power rectifying and communication circuits.

15. The system of claim 14, wherein each of the plurality of passive element readers comprises:
a signal transmission module; and
a host interface coupled to the signal transmission module.

16. The system of claim 15, wherein the signal transmission module comprises:
an antenna to transmit a portion of the RF signals at a distinct one of the plurality of frequencies;
an antenna switch coupled to the antenna;
a transmit circuit coupled between the antenna switch and the host interface; and
a receive circuit coupled between the antenna switch and the host interface, wherein the antenna switch selects between the transmit circuit and the receive circuit.

17. The system of claim 15, wherein the signal transmission module comprises:
a transmit antenna to transmit a portion of the RF signals at a distinct one of the plurality of frequencies;
a transmit circuit coupled between the transmit antenna and the host interface;
a receive antenna to receive RF signals at one of the plurality of frequencies; and
a receive circuit coupled between the receive antenna and the host interface.

18. A method comprising:
tuning a plurality of antennae to transmit and to receive radio frequency (RF) signals at a plurality of frequencies;
converting energy of the RF signals into direct current (DC) power;
receiving data in the RF signals;
transmitting data in the RF signals;
powering an electronic device using the DC power; and
processing the data using the electronic device.

19. The method of claim 18, wherein converting energy of the RF signals into DC power and to receive data in the RF signals comprises:
using a first capacitor, coupled to one of the plurality of antennae, to temporarily store the RF signals received; and
using a plurality of diodes coupled to the first capacitor, to rectify the RF signals received to generate the DC power.

20. The method of claim 19, further comprising:
storing the DC power in an energy storage device coupled to the electronic device.

21. The method of claim 20, wherein the energy storage device includes a second capacitor.

22. The method of claim 20, wherein the energy storage device includes an inductor.

23. The method of claim 20, wherein the energy storage device includes a battery.

24. An apparatus comprising:
means for transmitting and receiving radio frequency (RF) signals at a plurality of frequencies;
means for converting energy of the RF signals into direct current (DC) power;
means for receiving data in the RF signals;
means for transmitting data in the RF signals; and
means for powering an electronic device using the DC power, wherein the electronic device is operable to process the data in the RF signals.

25. The apparatus of claim 24, wherein the means for converting energy of the RF signals into the DC power comprises:
means for rectifying the RF signals.

26. The apparatus of claim 25, further comprising:
means for storing the DC power.

27. An apparatus comprising:
a multi-band antenna to transmit and to receive radio frequency (RF) signals at a plurality of frequencies, the multi-band antenna comprising a plurality of ports;
a plurality of rectifiers, each of the plurality of rectifiers coupled to a distinct one of the plurality of ports, to convert energy of the RF signals into direct current (DC) power;
a data receiver coupled to the multi-band antenna, to receive data in the RF signals; and
an electronic device coupled to the plurality of rectifiers and the data receiver, the electronic device to receive the DC power and the data from the plurality of rectifiers.

28. The apparatus of claim 27, further comprising:
a data transmitter coupled to the multi-band antenna, to transmit data in the RF signals.

29. The apparatus of claim 27, further comprising:
an energy storage device coupled to the plurality of rectifiers, to store the DC power.

30. An apparatus comprising:
a multi-band antenna to transmit and to receive radio frequency (RF) signals at a plurality of frequencies, the multi-band antenna comprising a plurality of ports;
a multi-band rectifier having a plurality of inputs, each of the plurality of inputs coupled to a distinct one of the plurality of ports, the multi-band rectifier operable to convert energy of the RF signals into direct current (DC) power;
a data receiver coupled to the multi-band antenna, to receive data in the RF signals; and
an electronic device coupled to the multi-band rectifier and the data receiver, the electronic device to receive the DC power and the data from the multi-band rectifier.

31. The apparatus of claim 30, further comprising:
a data transmitter coupled to the multi-band antenna, to transmit data in the RF signals.

32. The apparatus of claim 30, further comprising:
an energy storage device coupled to the multi-band rectifier, to store the DC power.

33. A passive element reader comprising:
a host interface; and
a signal transmission module coupled to the host interface, the signal transmission module comprising
one or more transmit antennae to transmit radio frequency (RF) signals at a plurality of frequencies to a passive element, wherein the passive element harvests power from the RF signals and reads data in the RF signals, wherein the passive element is powered by the power harvested from the RF signals, and
one or more receive antennae to receive RF signals at the plurality of frequencies transmitted from the passive element.

34. The passive element reader of claim 33, wherein the one or more transmit antennae comprise a multi-band transmit antenna.

35. The passive element reader of claim 33, wherein the one or more transmit antennae comprise a plurality of single-band transmit antennae.

36. The passive element reader of claim 33, wherein the one or more receive antennae comprise a multi-band receive antenna.

37. The passive element reader of claim 33, wherein the one or more receive antennae comprise a plurality of single-band receive antennae.

38. A method comprising:
generating radio frequency (RF) signals at a plurality of frequencies using a passive element reader; and
transmitting the RF signals from the passive element reader to a passive element to cause the passive element to harvest power from the RF signals and to read data in the RF signals, wherein the passive element is powered by the power harvested from the RF signals.

39. The method of claim 38, further comprising:
receiving RF signals from the passive element at the passive element reader.
